(19) United States
(12) Patent Application Publication
(10) Pub. No.: US 2008/0036370 A1
(43) Pub. Date: Feb. 14, 2008

(54) Polymer having 1,8-naphtalimide group and organic light emitting device including the same

(76) Inventors: Tae-Yong Noh, Gunpo-si (KR); Jong-Jin Park, Yongin-si (KR); Byoung-Ki Choi, Hwaseong-si (KR); Yu-Jin Kim, Suwon-si (KR); Woon-Jung Paek, Yongin-si (KR); Jhun-Mo Son, Yongin-si (KR); Shinichiro Tamura, Seongnam-si (KR)

Correspondence Address: ROBERT E. BUSHNELL, 1522 K STREET NW, SUITE 300, WASHINGTON, DC, 20005-1202, US

(21) Appl. No.: 11/657,112

(22) Filed: Jan. 24, 2007

(30) Foreign Application Priority Data
Jan. 24, 2006 (KR) 10-2006-0007272

(51) Int. Cl. C08F 32/08; H01J 1/63

(52) U.S. Cl. 313/504; 526/248; 526/259

(57) ABSTRACT

Provided is a polymer including a 1,8-naphtalimide group represented by Formula 1: 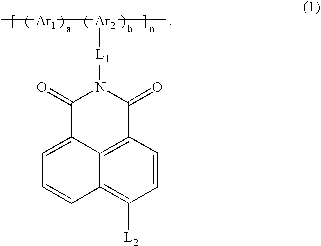 A polymer including a 1,8-naphtalimide group as a side chain shows high photoluminescence quantum efficiency and an organic light emitting device including the polymer has improved light emitting properties of efficiency and lifespan.

### CROSS-REFERENCE TO RELATED PATENT APPLICATION AND CLAIM OF PRIORITY

This application claims the benefit of Korean Patent Application No. 10-2006-0007272, filed on Jan. 24, 2006, in the Korean Intellectual Property Office, the disclosure of which is incorporated herein in its entirety by reference.

### BACKGROUND OF THE INVENTION

1. Field of the Invention

The present invention relates to a polymer having a 1,8-naphtalimide group and an organic light emitting device including the same and more particularly, to an organic light emitting device having improved light emitting efficiency and lifespan in which a polymer having a 1,8-naphtalimide group showing high photoluminescence quantum efficiency is used.

2. Description of the Related Art

Light-emitting devices are devices that generate and emit light and have wide angles of light emission, excellent contrast, and short response times. Light emitting devices can be categorized into inorganic light emitting devices having light emitting layers formed of inorganic compounds and organic light emitting devices (OLEDs) having light emitting layers formed of organic compounds. OLEDs have high brightness, low operating voltages, and short response times, and can realize emission of a wide range of colors, when compared to inorganic light emitting devices. As a result, a lot of research into OLEDs has been conducted.

In general, an OLED has a layered structure of anode/organic light emitting layer/cathode. In addition, an OLED can have various layered structures such as a structure of anode/hole injection layer/hole transport layer/light emitting layer/electron transport layer/electron injection layer/cathode or a structure of anode/hole injection layer/hole transport layer/light emitting layer/hole blocking layer/electron transport layer/electron injection layer/cathode.

Organic electroluminescence devices can be classified into devices using small molecules and devices using polymers according to properties of materials used and manufacturing process.

When a device is manufactured using small molecules, a vacuum deposition method is used to form a layer. Such a method can easily refine light emitting materials and realize a highly pure device. However, in order to apply this method, an increase of quantum efficiency, prevention of crystallization, and improvement of color purity are still required.

Research into organic electroluminescence devices using a polymer has been actively conducted after it was reported that light is emitted when electricity is applied to poly(1,4-phenylenevinylene) (PPV), which is a π-conjugated polymer. The π-conjugated polymer has a chemical structure in which a single bond (or π bond) and a double bond (or π bond) are alternatively included and thus, are not localized. Also, the π-conjugated polymer has π electrons which are relatively free to move along the bonded chain. With such semiconductor-like characteristics, when the π-conjugated polymer is applied to an emitting layer of an organic electroluminescence device, light of the visible light wavelength corresponding to a HOMO (Highest Occupied Molecular Orbital)-LUMO (Lowest Unoccupied Molecular Orbital) band-gap can be easily obtained by molecular design, and a thin membrane having excellent mechanical properties can be simply formed using a spin coating or printing method, as it has high glass transition temperature, bringing simple manufacturing process and low manufacturing cost. Examples of the polymer include polyacetylene, polythiophene, polyparaphenylene, polypyrrole, polybithiophene, polyisothianaphthene, polyphenylene vinylene, and polythienyl vinylene.

Currently, red and green polymer light emitting devices have adequate brightness, efficiency, and stability for use in a displaying device. In contrast, blue polymer light emitting device are inefficient and have short lifespans. Examples of the blue polymer may include poly(paraphenylene) (PPP) and poly(fluorene), for example, polyfluorene having a 9,9-dialkyl group. However, these polymers also have low efficiencies and short lifespans.

Therefore, in order to overcome problems of the conventional art, development of a polymer having a new structure and an organic electroluminescence device having improved light emitting efficiency and lifespan is required.

### SUMMARY OF THE INVENTION

The present invention provides a polymer including a 1,8-naphtalimide group.

The present invention also provides a composition including the polymer for a light emitting layer of a light emitting device.

The present invention also provides an organic light emitting device including the polymer.

According to an aspect of the present invention, there is provided a polymer including a 1,8-naphtalimide group represented by Formula 1:

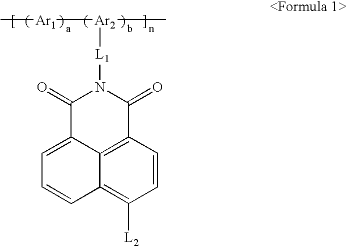

where Ar₁ and Ar₂ are each independently an arylene group, preferably, a substituted or unsubstituted C₆-C₃₀ arylene group, a substituted or unsubstituted C₂-C₃₀heteroarylene group, a substituted or unsubstituted C₅-C₃₀carbon ring group, or a substituted or unsubstituted C₂-C₃₀heterocyclic group and each of Ar₁ and Ar₂ may be the same or different;

L₁ is a substituted or unsubstituted C₆-C₃₀ arylene group, a substituted or unsubstituted C₂-C₃₀ heteroarylene group, a substituted or unsubstituted C₁-C₂₀ alkylene group, a substituted or unsubstituted C₁-C₂₀ cycloalkylene group, a substituted or unsubstituted C₁-C₂₀ heterocycloalkylene group, ether group, —N(L₂)— group, or —O—(CH₂)ₘ— group;

L₂ is hydrogen, halogen, a substituted or unsubstituted C₁-C₂₀ alkyl group, a substituted or unsubstituted C₁-C₂₀ cycloalkyl group, a substituted or unsubstituted C₁-C₂₀ heterocycloalkyl group, a substituted or unsubstituted C₆-C₃₀ aryl group, a substituted or unsubstituted C₂-C₃₀ heteroaryl group, an alkoxy group, an amine group, an alkylamine group, or a thioalkyl group;

n is a degree of polymerization which is a real number from 10 to 100,000;

a and b are molar ratios, where a+b=1 and 0.001≦b≦0.3; and

m is an integer from 1 to 20.

In the polymer above, examples of Ar₁ and Ar₂ may be each independently a substituted or unsubstituted phenylene group, a substituted or unsubstituted naphthylene group, a substituted or unsubstituted anthracenylene group, a substituted or unsubstituted phenanthrenylene group, a substituted or unsubstituted fluorenylene group, a substituted or unsubstituted carbazolylene group, a substituted or unsubstituted thiophenylene group, or a substituted or unsubstituted thiazolylene group.

According to an embodiment of the present invention, in the polymer above, the substituents of the arylene group, the heteroarylene group, the carbon ring group, the heterocyclic group, the alkylene group, the cycloalkylene group, the heterocycloalkylene group, the alkyl group, the cycloalkyl group, the heterocycloalkyl group, the aryl group, the heteroaryl group, and the alkoxy group may include at least one substituent selected from the group consisting of —F, —Cl, —Br, —CN, —NO₂, or —OH; a C₁-C₂₀ alkyl group unsubstituted or substituted with —F, —Cl, —Br, —CN, —NO₂, or —OH; a C₁-C₂₀ alkoxy group unsubstituted or substituted with —F, —Cl, —Br, —CN, —NO₂, or —OH; a C₆-C₃₀ aryl group unsubstituted or substituted with —F, —Cl, —Br, —CN, —NO₂, or —OH; a C₂-C₃₀ heteroaryl group unsubstituted or substituted with —F, —Cl, —Br, —CN, —NO₂, or —OH; and a C₅-C₂₀ cycloalkyl group unsubstituted or substituted with —F, —Cl, —Br, —CN, —NO₂, and —OH.

According to another embodiment of the present invention, in the polymer above, Ar₁ and Ar₂ may be each independently selected from the group consisting of a phenylene group, a C₁-C₁₀ alkylphenylene group, a C₁-C₁₀ alkoxyphenylene group, a halophenylene group, a cyanophenylene group, a dicyanophenylene group, a trifluoromethoxyphenylene group, an o-, m-, or p-tolylene group, an o-, m-, or p-cumenylene group, a mesitylene group, a phenoxyphenylene group, an (α,α-dimethylbenzene)phenylene group, a (N,N′-dimethyl)aminophenylene group, a (N,N′-diphenyl)aminophenylene group, a (C₁-C₁₀ alkylcyclohexyl)phenylene group, an (anthracenyl)phenylene group, a biphenylene group, a C₁-C₁₀ alkylbiphenylene group, a C₁-C₁₀ alkoxybiphenylene group, a pentalenyl group, an indenylene group, a naphthylene group, a C₁-C₁₀ alkylnaphthylene group, a C₁-C₁₀ alkoxynaphthylene group, a halonaphthylene group, a cyanonaphthylene group, a biphenylenylene group, a C₁-C₁₀ alkyl biphenylenylene group, a C₁-C₁₀ alkoxy biphenylenylene group, an anthracenylene group, an azulenylene group, a heptalenylene group, an acenaphthylenylene group, a phenalenylene group, a 9.9-dialkylfluorenylene group, a fluorenylene group, an anthraquinolylene group, a methylanthrylene group, a phenanthrenylene group, a triphenylenylene group, a pyrenylene group, a chrysenylene group, an ethyl-chrysenylene group, a picenylene group, a perylenylene group, a chloroperylenylene group, a pentaphenylene group, a pentacenylene group, a tetraphenylenylene group, a hexaphenylene group, a hexacenylene group, a rubicenylene group, a coronenylene group, a trinaphthylenylene group, a heptaphenylene group, a heptacenylene group, a pyranthrenylene group, an ovalenylene group, a carbazolylene group, a C₁₋₁₀ alkyl carbazolylene group, a thiophenylene group, an indolylene group, a purinylene group, a benzimidazolylene group, a quinolinylene group, a benzothiophenylene group, a parathiazinylene group, a pyrrolylene group, a pyrazolylene group, an imidazolylene group, an imidazolinylene group, an oxazolylene group, a thiazolylene group, a triazolylene group, a tetrazolylene group, an oxadiazolylene group, a pyridinylene group, a pyridazinylene group, a pyrimidinylene group, a pyrazinylene group, a thianthrenylene group, a pyrrolidinylene group, a pyrazolidinylene group, an imidazolidinylene group, a piperidinylene group, a piperazinylene group, and a morpholinylene group.

According to another embodiment of the present invention, in the polymer above, L₁ may selected from the group consisting of a phenylene group, a C₁-C₁₀ alkylphenylene group, a C₁-C₁₀ alkoxyphenylene group, a halophenylene group, a cyanophenylene group, a dicyanophenylene group, a trifluoromethoxyphenylene group, an o-, m-, or p-tolylene group, an o-, m-, or p-cumenylene group, a mesitylene group, a phenoxyphenylene group, an (α,α-dimethylbenzene)phenylene group, a (N,N′-dimethyl)aminophenylene group, a (N,N′-diphenyl)aminophenylene group, a (C₁-C₁₀ alkylcyclohexyl)phenylene group, an (anthracenyl)phenylene group, a biphenylene group, a C₁-C₁₀alkylbiphenylene group, a C₁-C₁₀ alkoxybiphenylene group, a pentalenylene group, an indenylene group, a naphthylene group, a C₁-C₁₀ alkylnaphthylene group, a C₁-C₁₀ alkoxynaphthylene group, a halonaphthylene group, a cyanonaphthylene group, a biphenylenylene group, a C₁-C₁₀ alkyl biphenylenylene group, a C₁-C₁₀ alkoxy biphenylenylene group, an anthracenylene group, an azulenylene group, a heptalenylene group, an acenaphthylenylene group, a phenalenylene group, a fluorenylene group, a 9,9-dialkylfluorenylene group, an anthraquinolylene group, a methylanthrylene group, a phenanthrenylene group, a triphenylenylene group, a pyrenylene group, a chrysenylene group, an ethyl-chrysenylene group, a picenylene group, a perylenylene group, a chloroperylenylene group, a pentaphenylene group, a pentacenylene group, a tetraphenylenylene group, a hexaphenylene group, a hexacenylene group, a rubicenylene group, a coronenylene group, a trinaphthylenylene group, a heptaphenylene group, a heptacenylene group, a pyranthrenylene group, an ovalenylene group, a carbazolylene group, a C₁₋₁₀alkyl carbazolylene group, a thiophenylene group, an indolylene group, a purinylene group, a benzimidazolylene group, a quinolinylene group, a benzothiophenylene group, a parathiazinylene group, a pyrrolylene group, a pyrazolylene group, an imidazolylene group, an imidazolinylene group, an oxazolylene group, a thiazolylene group, a triazolylene group, a tetrazolylene group, an oxadiazolylene group, a pyridinylene group, a pyridazinylene group, a pyrimidinylene group, a pyrazinylene group, a thianthrenylene group, a pyrrolidinylene group, a pyrazolidinylene group, an imidazolidinylene group, a piperidinylene group, a piperazinylene group, a carbazolylene group, a benzoxazolylene group, a phenothiazinylene group, a 5H-dibenzoazepinylene group, a 5H-tribenzoazepinylene group, a morpholinylene group, a methylene group, an ethylene group, a propylene group, a butylene group, a pentylene group, an ether group(—O—), —OCH₂—, —OCH₂CH₂—, —OCH₂CH₂CH₂—, —N(CH₃)—, and —N(CH₂CH₃)—.

According to another embodiment of the present invention, in the polymer above, L₂ may be selected from the group consisting of hydrogen, halogen, a methyl group, an ethyl group, a propyl group, a butyl group, a methoxy group, an ethoxy group, a propoxy group, a butoxy group, a C₁-C₁₀ alkylamine group, a C₁-C₁₀ thioalkyl group, a phenyl group, a C₁-C₁₀ alkylphenyl group, a C₁-C₁₀ alkoxyphenyl group, a halophenyl group, a cyanophenyl group, a dicyanophenyl group, a trifluoromethoxyphenyl group, an o-, m-, or p-tolyl group, an o-, m-, or p-cumenyl group, a mesityl group, a phenoxyphenyl group, an (α,α-dimethylbenzene)phenyl group, a (N,N′-dimethyl)aminophenyl group, a (N,N′-diphenyl)aminophenyl group, a (C₁-C₁₀ alkylcyclohexyl)phenyl group, an (anthracenyl)phenyl group, a biphenyl group, a C₁-C₁₀ alkylbiphenyl group, a C₁-C₁₀ alkoxybiphenyl group, a pentalenyl group, an indenyl group, a naphthyl group, a C₁-C₁₀ alkylnaphthyl group, a C₁-C₁₀ alkoxynaphthyl group, a halonaphthyl group, a cyanonaphthyl group, a biphenylenyl group, a C₁-C₁₀ alkyl biphenylenyl group, a C₁-C₁₀ alkoxy biphenylenyl group, an anthracenyl group, an azulenyl group, a heptalenyl group, an acenaphthylenyl group, a phenalenyl group, a fluorenyl group, a 9,9-dialkylfluorenyl group, an anthraquinolyl group, a methylanthryl group, a phenanthrenyl group, a triphenylenyl group, a pyrenyl group, a chrysenyl group, an ethyl-chrysenyl group, a picenyl group, a perylenyl group, a chloroperylenyl group, a pentaphenyl group, a pentacenyl group, a tetraphenylenyl group, a hexaphenyl group, a hexacenyl group, a rubicenyl group, a coronenyl group, a trinaphthylenyl group, a heptaphenyl group, a heptacenyl group, a pyranthrenyl group, an ovalenyl group, a carbazolyl group, a cyclopentyl group, and a cyclohexyl group.

According to another embodiment of the present invention, in the polymer above, L₂ may be represented by one from the group consisting of formulae below:

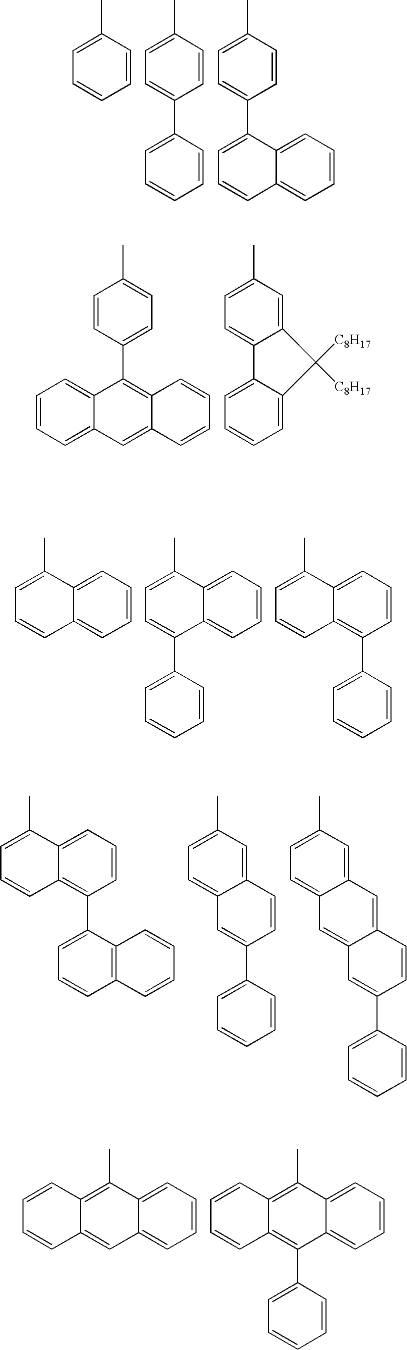

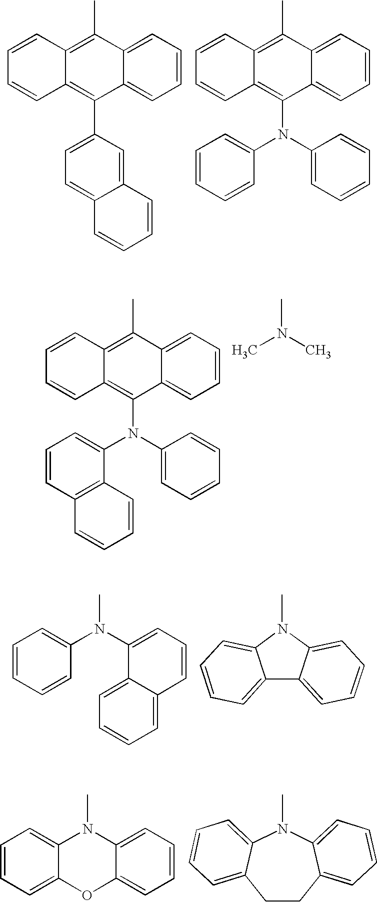

According to another embodiment of the present invention, the average number of molecular weight of the polymer may be 10,000 to 120,000.

According to another embodiment of the present invention, the glass transition temperature of the polymer may be 120 to 200° C.

According to another aspect of the present invention, there is provided a composition for a light emitting layer of a light emitting device, including: the polymer described above; and a phosphorescent or fluorescent dopant which emits red, green, blue, or white light.

According to another aspect of the present invention, there is provided an optoelectronic device including the polymer described above.

According to another aspect of the present invention, there is provided an organic light emitting device comprising: a first electrode; a second electrode; and an organic layer interposed between the first electrode and the second electrode, wherein the organic layer includes the polymer described above.

In an embodiment of the present invention, the organic layer may be one of a light emitting layer and a hole transport layer.

According to another embodiment of the present invention, the organic light emitting device may further include at least one layer interposed between the first electrode and the second electrode selected from the group consisting of a hole injection layer, a hole transport layer, an electron blocking layer, a hole blocking layer, an electron transport layer, and an electron injection layer.

According to another embodiment of the present invention, the organic light emitting device may have a structure selected from the group consisting of a first electrode/hole injection layer/light emitting layer/electron transport layer/electron injection layer/second electrode structure, a first electrode/hole injection layer/hole transport layer/light emitting layer/electron transport layer/electron injection layer/second electrode structure, and a first electrode/hole injection layer/hole transport layer/light emitting layer/hole blocking layer/electron transport layer/electron injection layer/second electrode structure.

According to another embodiment of the present invention, the emitting layer of the organic light emitting device may include a phosphorescent or fluorescent dopant which emits red, green, blue, or white light.

According to another aspect of the present invention, there is provided an organic light emitting device comprising: a first electrode; a second electrode; and an organic layer interposed between the first electrode and the second electrode, the organic layer comprising a light emitting layer and a hole transport layer interposed between the light emitting layer and the first electrode, the light emitting layer comprising the polymer doped with a dopant.

A polymer including a 1,8-naphtalimide group as a side chain according to the present invention shows high PL quantum efficiency. In contrast with a conventional blue polymer organic light emitting device having degraded property, an organic light emitting device including the polymer according to the present invention has improved light emitting properties in efficiency and lifespan.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1A through 1D are sectional views schematically illustrating structures of organic light emitting devices according to embodiments of the present invention.

### DETAILED DESCRIPTION OF THE INVENTION

Hereinafter, embodiments of the present invention will be described more fully.

A polymer including a 1,8-naphtalimide group according to an embodiment of the present invention is represented by formula 1:

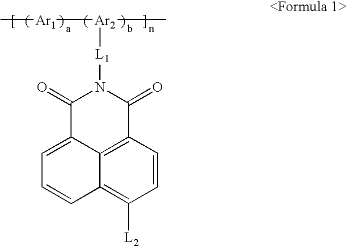

where Ar₁ and Ar₂ are each independently a substituted or unsubstituted C₆-C₃₀ arylene group, a substituted or unsubstituted C₂-C₃₀ heteroarylene group, a substituted or unsubstituted C₅-C₃₀ carbon ring group, or a substituted or unsubstituted C₂-C₃₀ heterocyclic group and Ar₁ and Ar₂ may be the same or different;

L₁ is a substituted or unsubstituted C₆-C₃₀ arylene group, a substituted or unsubstituted C₂-C₃₀ heteroarylene group, a substituted or unsubstituted C₁-C₂₀ alkylene group, a substituted or unsubstituted C₁-C₂₀ cycloalkylene group, a substituted or unsubstituted C₁-C₂₀ heterocycloalkylene group, ether group, —N(L₂)-group, or —O—(CH₂)ₘ— group;

L₂ is hydrogen, halogen, a substituted or unsubstituted C₁-C₂₀ alkyl group, a substituted or unsubstituted C₁-C₂₀ cycloalkyl group, a substituted or unsubstituted C₁-C₂₀ heterocycloalkyl group, a substituted or unsubstituted C₆-C₃₀ aryl group, a substituted or unsubstituted C₂-C₃₀ heteroaryl group, an alkoxy group, an amine group, an alkylamine group, or a thioalkyl group;

n is a degree of polymerization which is a real number from 10 to 100,000;

a and b are molar ratios, where a+b=1 and 0.001≦b≦0.3; and

m is an integer of 1 through 20.

In the above structure, a main chain of the polymer represented by Ar₁ and Ar₂ acts as host for transmitting energy and a 1,8-naphtalimide group acts as a guest for emitting light by converting electrical energy into light energy. In the polymer, a relative amount of Ar₁ and Ar₂ which are included in the main chain of the polymer can be adjusted so as to control a frequency of emitted light. In Formula 1, b may be 0.001 to 0.3, preferably, 0.002 to 0.1.

In the polymer above, examples of Ar₁ and Ar₂ may be any arylene group which used in the art. Preferably, Ar₁ and Ar₂ are each independently a substituted or unsubstituted phenylene group, a substituted or unsubstituted naphthylene group, a substituted or unsubstituted anthracenylene group, a substituted or unsubstituted phenanthrenylene group, a substituted or unsubstituted fluorenylene group, a substituted or unsubstituted carbazolylene group, a substituted or unsubstituted thiophenylene group, or a substituted or unsubstituted thiazolylene group but are not limited thereto. Ar₁ and Ar₂ may be the same or different.

In the polymer above, the substituents of the arylene group, the heteroarylene group, the carbon ring group, the heterocyclic group, the alkylene group, the cycloalkylene group, the heterocycloalkylene group, the alkyl group, the cycloalkyl group, the heterocycloalkyl group, the aryl group, the heteroaryl group, and the alkoxy group may be —F, —Cl, —Br, —CN, —NO₂, or —OH; a C₁-C₂₀ alkyl group unsubstituted or substituted with —F, —Cl, —Br, —CN, —NO₂, or —OH; a C₁-C₂₀ alkoxy group unsubstituted or substituted with —F, —Cl, —Br, —CN, —NO₂, or —OH; a C₆-C₃₀ aryl group unsubstituted or substituted with —F, —Cl, —Br, —CN, —NO₂, or —OH; a C₂-C₃₀ heteroaryl group unsubstituted or substituted with —F, —Cl, —Br, —CN, —NO₂, or —OH; and a C₅-C₂₀ cycloalkyl group unsubstituted or substituted with —F, —Cl, —Br, —CN, —NO₂, or —OH but are not limited thereto. Any substituents improving light emitting efficiency of a polymer which is well known in the art can be used.

More specifically, examples of Ar₁ and Ar₂ in the polymer are a phenylene group, a C₁-C₁₀ alkylphenylene group, a C₁-C₁₀ alkoxyphenylene group, a halophenylene group, a cyanophenylene group, a dicyanophenylene group, a trifluoromethoxyphenylene group, an o-, m-, or p-tolylene group, an o-, m-, or p-cumenylene group, a mesitylene group, a phenoxyphenylene group, an (α,α-dimethylbenzene)phenylene group, a (N,N′-dimethyl)aminophenylene group, a (N,N′-diphenyl)aminophenylene group, a (C₁-C₁₀ alkylcyclohexyl)phenylene group, an (anthracenyl)phenylene group, a biphenylene group, a C₁-C₁₀ alkylbiphenylene group, a C₁-C₁₀ alkoxybiphenylene group, a pentalenyl group, an indenylene group, a naphthylene group, a C₁-C₁₀ alkylnaphthylene group, a C₁-C₁₀ alkoxynaphthylene group, a halonaphthylene group, a cyanonaphthylene group, a biphenylenylene group, a C₁-C₁₀ alkyl biphenylenylene group, a C₁-C₁₀ alkoxy biphenylenylene group, an antracenylene group, an azulenylene group, a heptalenylene group, an acenaphthylenylene group, a phenalenylene group, a 9.9-dialkylfluorenylene group, a fluorenylene group, an anthraquinolylene group, a methylanthrylene group, a phenanthrenylene group, a triphenylenylene group, a pyrenylene group, a chrysenylene group, an ethyl-chrysenylene group, a picenylene group, a perylenylene group, a chloroperylenylene group, a pentaphenylene group, a pentacenylene group, a tetraphenylenylene group, a hexaphenylene group, a hexacenylene group, a rubicenylene group, a coronenylene group, a trinaphthylenylene group, a heptaphenylene group, a heptacenylene group, a pyranthrenylene group, an ovalenylene group, a carbazolylene group, a C₁₋₁₀ alkyl carbazolylene group, a thiophenylene group, an indolylene group, a purinylene group, a benzimidazolylene group, a quinolinylene group, a benzothiophenylene group, a parathiazinylene group, a pyrrolylene group, a pyrazolylene group, an imidazolylene group, an imidazolinylene group, an oxazolylene group, a thiazolylene group, a triazolylene group, a tetrazolylene group, an oxadiazolylene group, a pyridinylene group, a pyridazinylene group, a pyrimidinylene group, a pyrazinylene group, a thianthrenylene group, a pyrrolidinylene group, a pyrazolidinylene group, an imidazolidinylene group, a piperidinylene group, a piperazinylene group, or a morpholinylene group but are not limited thereto. Any arylene compound having one ring or a plurality of rings which is well known in the art can be used. In addition, Ar₁ and Ar₂ may be the same or different.

L₁ of the polymer may be a phenylene group, a C₁-C₁₀ alkylphenylene group, a C₁-C₁₀ alkoxyphenylene group, a halophenylene group, a cyanophenylene group, a dicyanophenylene group, a trifluoromethoxyphenylene group, an o-, m-, or p-tolylene group, an o-, m-, or p-cumenylene group, a mesitylene group, a phenoxyphenylene group, an (α,α-dimethylbenzene)phenylene group, a (N,N′-dimethyl)aminophenylene group, a (N,N′-diphenyl)aminophenylene group, a (C₁-C₁₀ alkylcyclohexyl)phenylene group, an (anthracenyl)phenylene group, a biphenylene group, a C₁-C₁₀alkylbiphenylene group, a C₁-C₁₀ alkoxybiphenylene group, a pentalenylene group, an indenylene group, a naphthylene group, a C₁-C₁₀ alkylnaphthylene group, a C₁-C₁₀ alkoxynaphthylene group, a halonaphthylene group, a cyanonaphthylene group, a biphenylenylene group, a C₁-C₁₀ alkyl biphenylenylene group, a C₁-C₁₀ alkoxy biphenylenylene group, an antracenylene group, an azulenylene group, a heptalenylene group, an acenaphthylenylene group, a phenalenylene group, a fluorenylene group, a 9,9-dialkylfluorenylene group, an anthraquinolylene group, a methylanthrylene group, a phenanthrenylene group, a triphenylenylene group, a pyrenylene group, a chrysenylene group, an ethyl-chrysenylene group, a picenylene group, a perylenylene group, a chloroperylenylene group, a pentaphenylene group, a pentacenylene group, a tetraphenylenylene group, a hexaphenylene group, a hexacenylene group, a rubicenylene group, a coronenylene group, a trinaphthylenylene group, a heptaphenylene group, a heptacenylene group, a pyranthrenylene group, an ovalenylene group, a carbazolylene group, a C₁₋₁₀alkyl carbazolylene group, a thiophenylene group, an indolylene group, a purinylene group, a benzimidazolylene group, a quinolinylene group, a benzothiophenylene group, a parathiazinylene group, a pyrrolylene group, a pyrazolylene group, an imidazolylene group, an imidazolinylene group, an oxazolylene group, a thiazolylene group, a triazolylene group, a tetrazolylene group, an oxadiazolylene group, a pyridinylene group, a pyridazinylene group, a pyrimidinylene group, a pyrazinylene group, a thianthrenylene group, a pyrrolidinylene group, a pyrazolidinylene group, an imidazolidinylene group, a piperidinylene group, a piperazinylene group, a carbazolylene group, a benzoxazolylene group, a phenothiazinylene group, a 5H-dibenzoazepinylene group, a 5H-tribenzoazepinylene group, a morpholinylene group, a methylene group, an ethylene group, a propylene group, a butylene group, a pentylene group, an ether group(—O—), —OCH₂—, —OCH₂CH₂—, —OCH₂CH₂CH₂—, —N(CH₃)—, or —N(CH₂CH₃)— but is not limited thereto. Any substituents which are well known in the art can be used.

L₂ of the polymer may be hydrogen, halogen, a methyl group, an ethyl group, a propyl group, a butyl group, a methoxy group, an ethoxy group, a propoxy group, a butoxy group, a C₁-C₁₀ alkylamine group, a C₁-C₁₀ thioalkyl group, a phenyl group, a C₁-C₁₀ alkylphenyl group, a C₁-C₁₀ alkoxyphenyl group, a halophenyl group, a cyanophenyl group, a dicyanophenyl group, a trifluoromethoxyphenyl group, an o-, m-, or p-tolyl group, an o-, m-, or p-cumenyl group, a mesityl group, a phenoxyphenyl group, an (α,α-dimethylbenzene)phenyl group, a (N,N′-dimethyl)aminophenyl group, a (N,N′-diphenyl)aminophenyl group, a (C₁-C₁₀ alkylcyclohexyl)phenyl group, an (anthracenyl)phenyl group, a biphenyl group, a C₁-C₁₀ alkylbiphenyl group, a C₁-C₁₀ alkoxybiphenyl group, a pentalenyl group, an indenyl group, a naphthyl group, a C₁-C₁₀ alkylnaphthyl group, a C₁-C₁₀ alkoxynaphthyl group, a halonaphthyl group, a cyanonaphthyl group, a biphenylenyl group, a C₁-C₁₀ alkyl biphenylenyl group, a C₁-C₁₀ alkoxy biphenylenyl group, an anthracenyl group, an azulenyl group, a heptalenyl group, an acenaphthylenyl group, a phenalenyl group, a fluorenyl group, a 9,9-dialkylfluorenyl group, an anthraquinolyl group, a methylanthryl group, a phenanthrenyl group, a triphenylenyl group, a pyrenyl group, a chrysenyl group, a ethyl-chrysenyl group, a picenyl group, a perylenyl group, a chloroperylenyl group, a pentaphenyl group, a pentacenyl group, a tetraphenylenyl group, a hexaphenyl group, a hexacenyl group, a rubicenyl group, a coronenyl group, a trinaphthylenyl group, a heptaphenyl group, a heptacenyl group, a pyranthrenyl group, an ovalenyl group, a carbazolyl group, a cyclopentyl group, or a cyclohexyl group but is not limited thereto. Any substituents improving light emitting efficiency of a polymer which are well known in the art can be used.

L₂ of the polymer may be represented by any one of Formulae below:

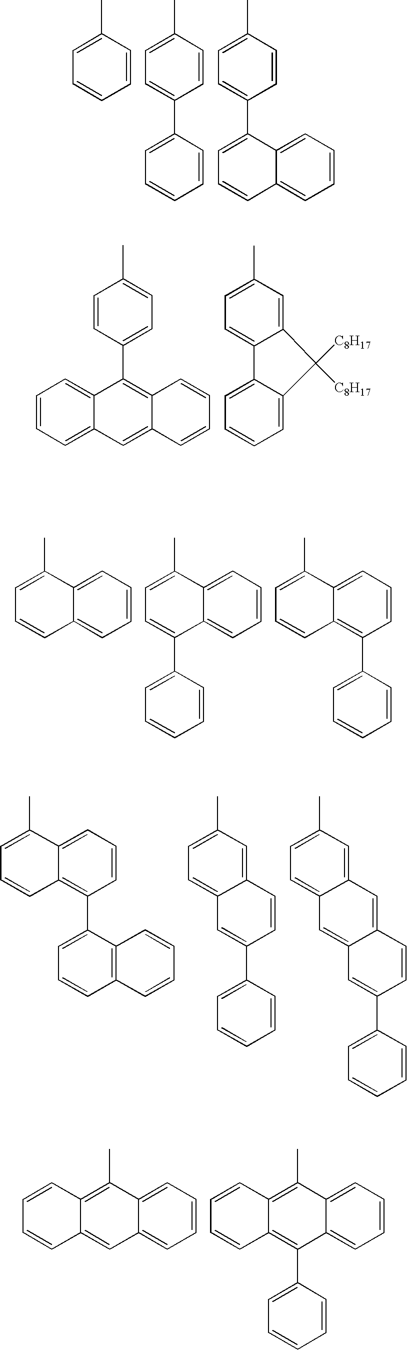

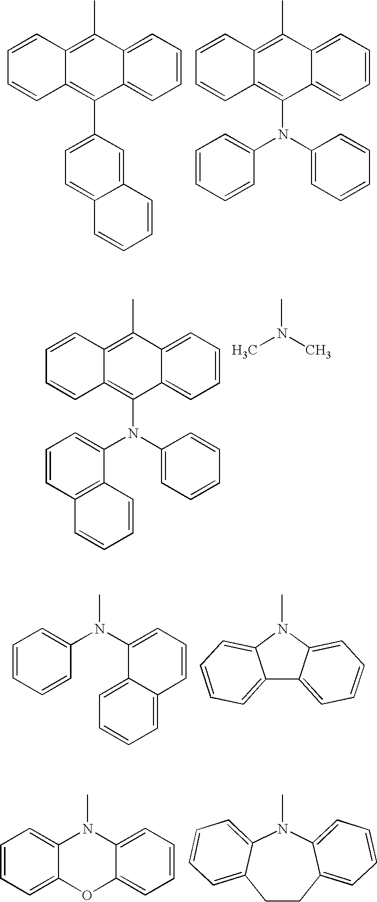

The average molecular weight of the polymer may be from 10,000 to 120,000. When the average molecular weight is less than 10,000, uniformity of a layer thereof is low due to crystallization. When the average molecular weight is above 120,000, manufacture of a layer using the polymer is difficult due to low solubility.

The glass transition temperature of the polymer may be 120 to 200° C. When the glass transition temperature is less than 120° C., heat resistance to heat generation of a device is low. When the glass transition temperature is above 200° C., monomer breaks down during polymerization.

A composition for a light emitting layer of a light emitting device according to an embodiment of the present invention includes the polymer and a phosphorescent or fluorescent dopant which emits red, green, blue, or white light. An organic light emitting device using the composition improves the light emitting efficiency of a light emitting device.

An optoelectronic device according to an embodiment of the present invention includes the polymer. The polymer is conductive and has a functional group able to emit light so the polymer can be used in various electroluminescent devices, for example, a light emitting device.

An organic electroluminescence device according to an embodiment of the present invention includes a first electrode, a second electrode, and an organic layer interposed between the first electrode and the second electrode. The organic layer includes the polymer represented by Formula 1.

Since the polymer includes a 1,8-naphtalimide group within a molecule, photoluminescence (PL) quantum efficiency is high. When the compound is used in the device, efficiency and lifespan of the device may increase. Accordingly, the organic layer including the polymer represented by Formula 1 may be a light emitting layer or hole transport layer.

The organic electroluminescence device according to embodiments of the present invention has various structures. The device may further include at least one layer interposed between the first electrode and the second electrode selected from the group consisting of a hole injection layer, a hole transport layer, an electron blocking layer, a hole blocking layer, an electron transport layer, and an electron injection layer.

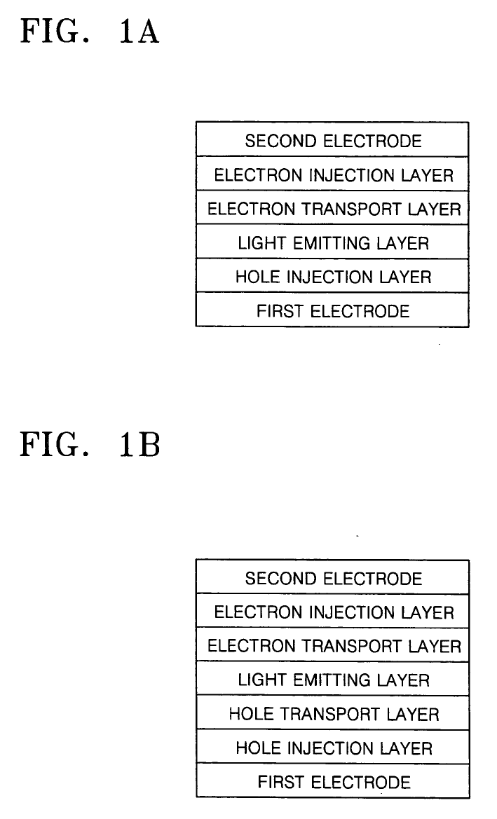

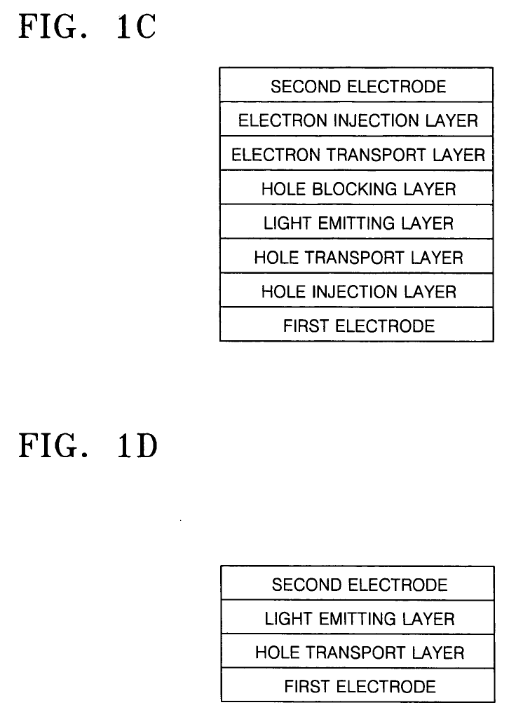

More specifically, organic light emitting devices according to embodiments of the present invention are illustrated in FIGS. 1A, 1B, and 1C. FIG. 1A is a sectional view schematically illustrating an organic light emitting device having a first electrode/hole injection layer/light emitting layer/electron transport layer/electron injection layer/second electrode structure. FIG. 1B is a sectional view schematically illustrating an organic light emitting device having a first electrode/hole injection layer/hole transport layer/light emitting layer/electron transport layer/electron injection layer/second electrode structure. FIG. 1C is a sectional view schematically illustrating an organic light emitting device having a first electrode/hole injection layer/hole transport layer/light emitting layer/hole blocking layer/electron transport layer/electron injection layer/second electrode structure. In these embodiments, the light emitting layer may include the polymer according to an embodiment of the present invention.

A light emitting layer of the organic light emitting device according to the embodiments of the present invention may contain a phosphorescent or fluorescent dopant which emits red, green, blue, or white light. The phosphorescent dopant may include at least one organometallic compound selected from the group consisting of Ir, Pt, Os, Ti, Zr, Hf, Eu, Tb, and Tm.

A method of manufacturing the organic light emitting device according to an embodiment of the present invention will now be described with reference to the organic light emitting device illustrated in FIG. 1D.

First, a high work function material is deposited on a substrate using a depositing method or a sputtering method to form a first electrode. The first electrode can be an anode. The substrate may be a substrate that is commonly used in a conventional organic light emitting display device. For example, the substrate may be a glass substrate or a transparent plastic substrate, both of which have mechanical strength, thermal stability, and plane surfaces, are transparent and waterproof, and can be easily handled. The first electrode material may be a conductive transparent material, such as indium tin oxide (ITO), indium zinc oxide (IZO), tin oxide (SnO₂), zinc oxide (ZnO), and the like.

Then, a hole transport layer (HTL) can be formed on the first electrode using various methods, such as a vacuum depositing method, a spin coating method, a casting method, a LB method, or the like.

When the HTL is formed by vacuum deposition, deposition conditions may vary according to compounds used to form the HTL and the structure and thermal properties of the HTL which will be formed. For example, a deposition temperature may be in the range of 100 to 500° C., a deposition pressure may be in the range of 10⁻⁸ to 10⁻³ torr, a deposition rate may be in the range of 0.01 to 100 Å/sec, and a thickness of the HTL may be in the range of 10 Å to 5 μm.

When the HTL is formed by spin coating, coating conditions may vary according to compounds used to form the HTL and the structure and thermal properties of the HTL which will be formed. A coating speed may be in the range of about 2,000 rpm to 5,000 rpm, and a baking process may be performed after the coating process. The temperature of the baking process may be in the range of about 50° C. to 250° C.

The materials which can be used to form the HTL are not limited, and any well known materials used generally to form an HTL can be used. For example, carbazole derivatives such as polyvinylcarbazole (PVK) represented by Formula 2 and the like, and PEDOT/PSS (poly(3,4-ethylenedioxythiophene)/polystyreneparasulfonate).

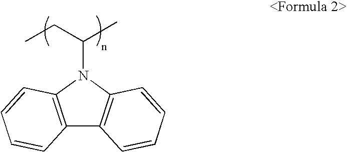

The thickness of the HTL may be in the range of about 5 to 100 nm, for example, 10 to 60 nm. When the thickness of the HTL is less than 5 nm, hole transportation may be degraded. When the thickness of the HTL is above 100 nm, the operating voltage may increase.

Subsequently, a light emitting layer (EML) can be formed on the HTL by spin coating, casting, or the like. When the EML is formed by spin coating or casting, the condition of coating may vary according to compounds used to form the EML and may be the same as when the HTL is formed.

The materials that can be used to form the EML are not limited, and may be various compounds, for example the polymer represented by Formula 1.

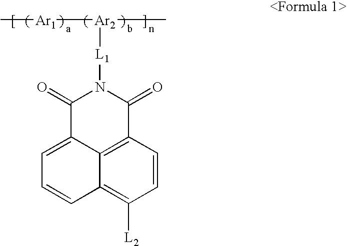

where Ar1, Ar2, L₁, L₂, n, a, and b are defined as above.

Examples of the polymer are not limited but the polymer represented by Formulae 3 through 5.

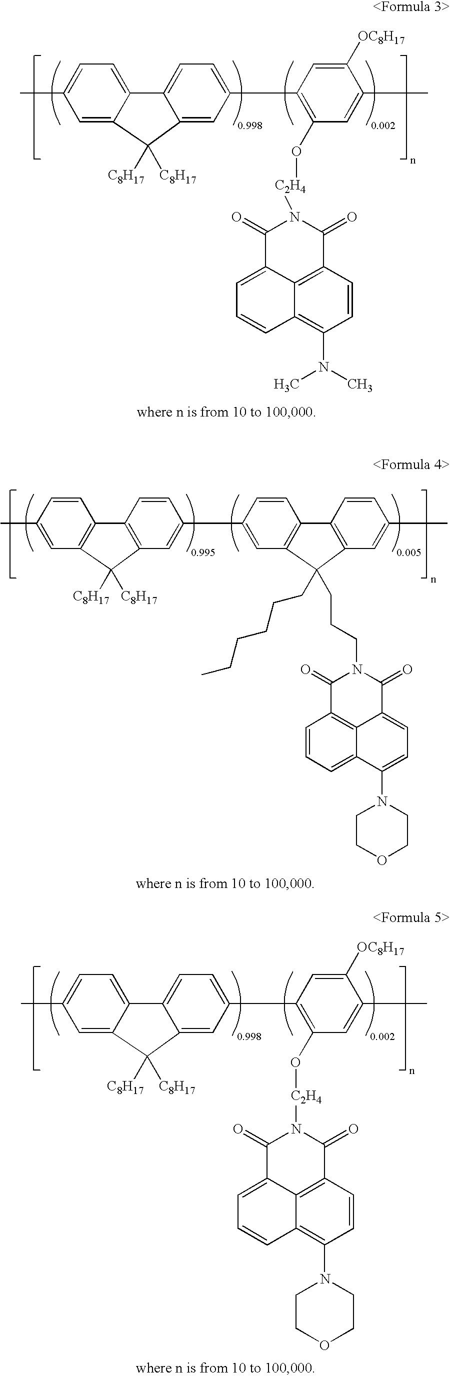

Furthermore, other well known dopants, in addition to the compound according to an embodiment of the present invention, can be used to form the EML. For example, a fluorescent dopant can be IDE102 or IDE105 (produced by Idemitsu Kosan, Co., Ltd.), or C545T (produced by Hayashibara Inc.); and a phosphorescent dopant can be PtOEP or RD 61 (produced by UDC Inc.) as a red phosphorescent dopant, Ir(PPy)₃(PPy=2-phenylpyridine) as a green phosphorescent dopant, and F2Irpic as a blue phosphorescent dopant

The concentration of the dopant used is not limited, and may be in the range of 0.01 to 15 parts by weight based on 100 parts by weight of a host.

The thickness of the EML may be in the range of 10-100 nm, for example, 20-60 nm. When the thickness of the EML is less than 10 nm, light emitting properties may deteriorate. When the thickness of the EML is above 100 nm, the operating voltage may increase.

Subsequently, a second electrode can be formed on the EML using a vacuum deposition method or a sputtering method. The second electrode can be used as a cathode. The material used to form the second electrode can be a metal, an alloy, an electrically conductive compound, or a mixture of these, which has a low work function. For example, the second electrode forming metal can be Li, Mg, Al, Al—Li, Ca, Mg—In, Mg—Ag, or the like. In contrast, laminates of BaF₂/Ca/Al and Ca/Al can be used. Meanwhile, in order to obtain a front emission type light emitting device, the cathode can be formed of a transparent material, such as ITO or IZO.

In addition, the light emitting device may further include layers which will be described below.

A hole injection layer (HIL) can be formed on the first electrode using various methods, such as a spin coating method, a casting method, or the like.

When the HIL is formed by spin coating, coating condition may vary according to the compound used to form the HIL and the structure and thermal properties of the HIL which will be formed. A coating speed may be in the range of about 2000 to 5000 rpm, and a heat treatment temperature for removing a solvent after the coating may be in the range of about 80 to 200° C.

The material used to form the HIL is not limited, and may be a conductive soluble polymer such as Pani/DBSA (Polyaniline/Dodecylbenzenesulfonic acid) represented by Formula 6, PEDOT/PSS (Poly(3,4-ethylenedioxythiophene)/Poly(4-styrenesulfonate) represented by Formula 7, Pani/CSA (Polyaniline/Camphor sulfonic acid), or PANI/PSS (Polyaniline)/Poly(4-styrenesulfonate).

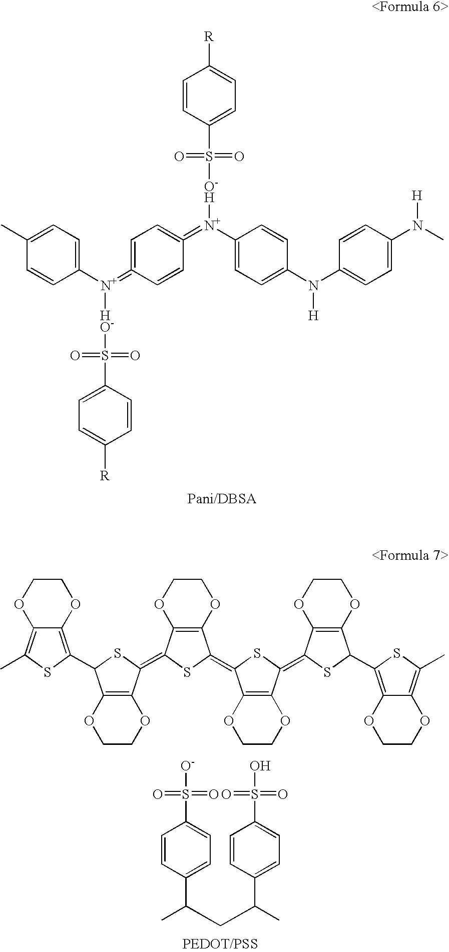

The thickness of the HIL may be in the range of about 100 to 10000 Å, for example, 100 to 1000 Å. When the thickness of the HIL is less than 100 Å, hole injection may be degraded. When the thickness of the HIL is above 10000 Å, the operating voltage may increase.

When the EML is formed using a phosphorescent dopant, a hole blocking layer (HBL) can be formed on the HTL using a vacuum deposition method, a spin coating method, a casting method, LB, or the like to prevent diffusion of triple excimers or holes into an electron transport layer. When the HBL is formed by vacuum deposition and spin coating, the vacuum deposition condition or spin coating condition may vary according to the compound used to form the HBL and may be almost the same as when the HIL is formed. A known, available material used to form the HBL can be, for example, an oxadiazole derivative, a triazole derivative, a phenanthroline derivative, a material disclosed in JP 11-329734(A1), BCP, or the like.

The thickness of the HBL may be in the range of about 50 to 1000 Å, for example, 100 to 300 Å. When the thickness of the HBL is less than 50 Å, a hole blocking property may decrease. When the thickness of the HBL is above 1000 Å, the operating voltage may increase.

Subsequently, an electron transport layer (ETL) can be formed using a vacuum deposition method, a spin coating method, a casting method, or the like. When the ETL is formed by vacuum deposition or spin coating, the vacuum deposition conditions or spin coating conditions may vary according to the compound used to form the ETL and may be almost the same as when the HIL is formed. The compound used to form the ETL stably transports electrons injected from an electron injection electrode (cathode) and may be a quinoline derivative, such as tris(8-quinolinolate)aluminum(Alq₃) or TAZ represented by Formula 8.

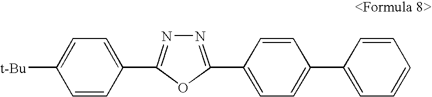

The thickness of the ETL may be in the range of about 100-1000 Å, for example, 200-500 Å. When the thickness of the ETL is less than 100 Å, electron transportation may be degraded. When the thickness of the ETL is above 1000 Å, the operating voltage may increase.

An electron injection layer (EIL), which allows easy injection of electrons from a cathode, can be formed on the ETL. The material used to form the EIL is not particularly restricted.

The EIL can be formed of any known material used to form an EIL, such as LiF, NaCl, CsF, Li₂O, BaO, or the like. Conditions for depositing the EIL may vary according to material used to form the EIL and may be almost the same as when the HIL is formed.

The thickness of the EIL may be in the range of about 1-100 Å, for example, 5 to 50 Å. When the thickness of the EIL is less than 1 Å, electron injection may be degraded. When the thickness of the EIL is above 100 Å, the operating voltage may increase.

An organic light emitting device according to an embodiment of the present invention may have various structures, in addition to the structure of an organic light-emitting device including a first electrode, a HTL, an EML, and a second electrode illustrated in FIG. 1D.

The polymer of Formula 1 was prepared according to a conventional organic synthesis method. Synthesis products were determined using 1 H NMR and a Mass Spectrometer.

Hereinafter, Synthesis Examples and Examples for preparing Compounds 3, 4, and 5 respectively represented by Formulae 3, 4, and 5 (hereinafter, referred to as “Compound 3”, “Compound 4”, and “Compound 5”) according to embodiments of the present invention will be described in detail.

The present invention will be described in greater detail with reference to the following examples. The following examples are for illustrative purposes and are not intended to limit the scope of the invention.

### EXAMPLES

### Synthesis Example 1

Compound 3 was synthesized according to a reaction path of Reaction Scheme 1:

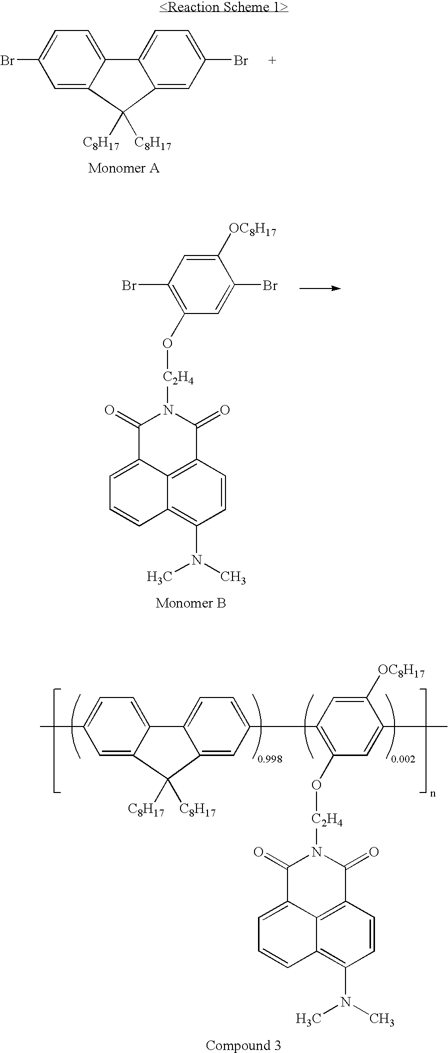

10.97 g (20 mmol) of monomer A was dissolved in 200 ml of anhydrous toluene in a flask in a nitrogen atmosphere and 8.25 g (30 mmol) of Ni(COD)2, 4.69 g (30 mmol) of bipyridal (BPy), 5.40 g (50 mmol) of COD, and 26 mg (0.04 mmol) of monomer B were added thereto and stirred for 24 hours at 80° C. The reaction mixture cooled down to 60° C. and was poured into a solvent mixture (HCl:aceton:methanol=1:1:2) and stirred for 12 hours to form precipitates. After the precipitate was collected, it was dissolved in chloroform and precipitated in methanol to obtain 4.3 g of compound 3 (Yield: 55%).

### Synthesis Example 2

Compound 4 was synthesized according to a reaction path of Reaction Scheme 2:

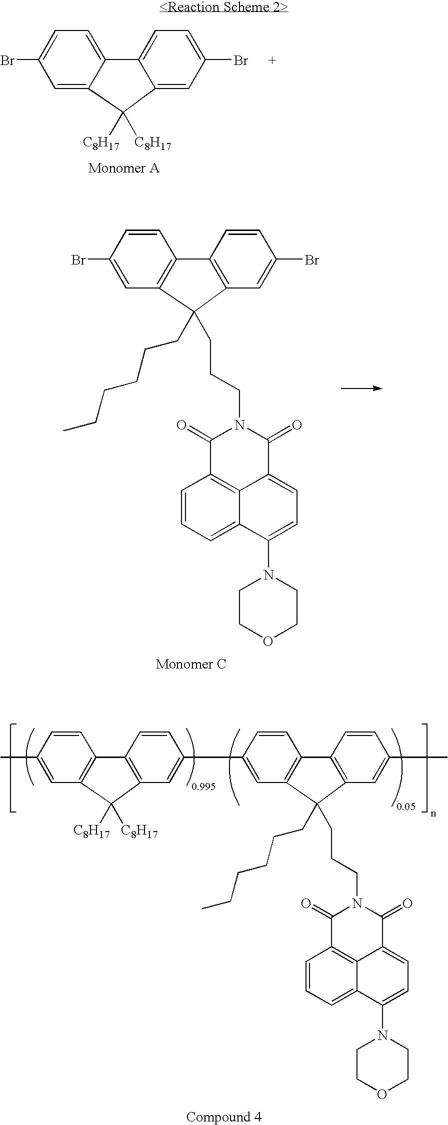

3.5 g of compound 4 (Yield: 45%) was obtained in the same manner as in Synthesis Example 1, except that monomer C was used instead of monomer B which was used during synthesis of compound 3 of Synthesis Example 1.

### Synthesis Example 3

Compound 5 was synthesized according to a reaction path of Reaction Scheme 3:

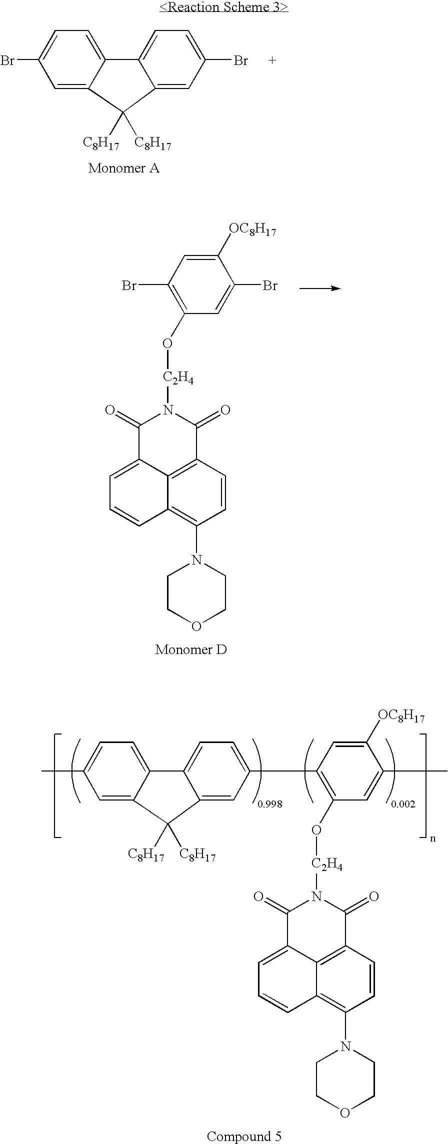

4.1 g of compound 5 (Yield: 53%) was obtained in the same manner as in Synthesis Example 1, except that monomer D was used instead of monomer B which was used during synthesizing of compound 3 of Synthesis Example 1.

### Testing Example 1

### Measuring basic properties

Basic properties of compound 3 synthesized in Synthesis Example 1 were measured.

The average molecular weight of compound 3 was 60,000 and a glass transition temperature (Tg) was 126° C.

### Example 1

An organic light emitting device was manufactured using compound 3 as a dopant of a light emitting layer. The structure of the organic light emitting device is ITO/(PEDOT:PSS)(50 nm)/compound 3 (70 nm)/BaF₂(4 nm)/Ca(2 nm)/AI(150 nm).

In order to prepare an anode, an ITO glass substrate 15Ω/cm² (1500 Å) produced by Corning Inc. was cut to a size of 50 mm×50 mm×0.7 mm, sonicated using isopropyl alcohol and pure water for 5 minutes, and washed using ultra violet (UV) ozone for 10 minutes. Then, PEDOT-PSS (AI4083) was coated on the substrate and heat treated at 120° C. for 10 minutes to form an HTL having a thickness of 50 nm.

The polymer represented by Formula 3 was spin coated on the HTL and then heat treated at 200° C. for 1 hour to form an EML having a thickness of 70 nm. Then, a cathode having a structure of BaF₂(4 nm)/Ca(2 nm)/Al(150 nm) was sequentially vacuum deposited on the EML to manufacture a polymer organic light emitting device having the structure of the device illustrated in FIG. 1D.

### Example 2

An organic light emitting device was manufactured in the same manner as in Example 1, except that the compound 4 was used as a light emitting layer instead of compound 3.

### Comparative Example 1

An organic light emitting device was manufactured in the same manner as in Example 1, except that polyfluorene having an average molecular weight of 60,000 represented by the compound 9 was used to form an emitting layer instead of compound 3.

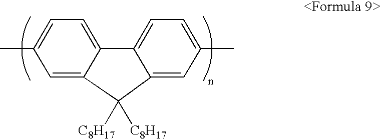

### Evaluation Example

### Device Properties of Examples 1 through 2 and Comparative Example 1

Current efficiency, lifespan, and color purity of Examples 1 through 2 and Comparative Example 1 were measured using a PR650 (Spectroscan) Source Measurement Unit. The results are shown in Table 1.

TABLE 1

| | | CIE | |
|---|---|---|---|
| | Lifespan | Color coordinate | Current efficiency at |
| | (hr, @100 cd/m²) | (x, y) | 10 V (cd/A) |
| Example 1 | 430 | (0.16, 0.18) | 2.00 |
| Example 2 | 320 | (0.15, 0.21) | 6.00 |
| Comparative | 0.8 | (0.17, 0.10) | 0.82 |
| Example 1 | | | |

As illustrated in Table 1, Examples in which hole transporting materials according to embodiments of the present invention are added in the emitting layer shows longer lifespan, improved color purity, and higher current efficiency than that of Comparative Example 1. Such results were obtained because efficiency of energy conversion is improved due to introduction of light emitting materials having a new structure in which the main chain of the polymer shows high PL quantum efficiency and stability of the device increases by suppressing transfer of the light emitting materials from being diffused since they were connected with the polymer.

In addition, light emitting materials having low concentration were connected with the polymer so as to form a structure in which energy transfer is induced. Accordingly, thermal stability and electric charge transfer of compounds of Examples 1 through 2 according to embodiments of the present invention are improved compared with the Comparative Example 1, thereby increasing lifespan and efficiency of the light emitting materials according to embodiments of the present invention compared to polymers only having a main chain.

As described above, a polymer including a 1,8-naphtalimide group as a side chain according to the present invention shows high PL quantum efficiency and an organic electroluminescence device including the polymer has improved light emitting properties of efficiency and lifespan.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A polymer including a 1,8-naphtalimide group represented by Formula 1: 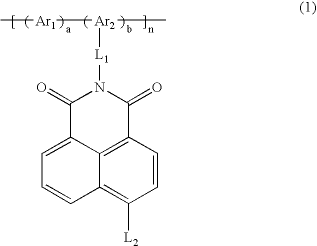
where Ar₁ and Ar₂ are each independently a substituted or unsubstituted C₆-C₃₀ arylene group, a substituted or unsubstituted C₂-C₃₀ heteroarylene group, a substituted or unsubstituted C₅-C₃₀ carbon ring group, or a substituted or unsubstituted C₂-C₃₀ heterocyclic group, and each of Ar₁ and Ar₂ may be the same or different;
L₁ is a substituted or unsubstituted C₆-C₃₀ arylene group, a substituted or unsubstituted C₂-C₃₀ heteroarylene group, a substituted or unsubstituted C₁-C₂₀ alkylene group, a substituted or unsubstituted C₁-C₂₀ cycloalkylene group, a substituted or unsubstituted C₁-C₂₀ heterocycloalkylene group, ether group, —N(L₂)— group, or —O—(CH₂)ₘ— group;
L₂ is hydrogen, halogen, a substituted or unsubstituted C₁-C₂₀ alkyl group, a substituted or unsubstituted C₁-C₂₀ cycloalkyl group, a substituted or unsubstituted C₁-C₂₀ heterocycloalkyl group, a substituted or unsubstituted C₆-C₃₀ aryl group, a substituted or unsubstituted C₂-C₃₀ heteroaryl group, an alkoxy group, an amine group, an alkylamine group, or a thioalkyl group;
n is a degree of polymerization which is a real number from 10 to 100,000;
a and b are molar ratios, where a+b=1 and 0.001≦b≦0.3; and
m is an integer from 1 to 20.

2. The polymer of claim 1, wherein Ar₁ and Ar₂ are each independently a substituted or unsubstituted phenylene group, a substituted or unsubstituted naphthylene group, a substituted or unsubstituted antracenylene group, a substituted or unsubstituted phenanthrenylene group, a substituted or unsubstituted fluorenylene group, a substituted or unsubstituted carbazolylene group, a substituted or unsubstituted thiophenylene group, or a substituted or unsubstituted thiazolylene group.

3. The polymer of claim 1, wherein the substituents of the arylene group, the heteroarylene group, the carbon ring group, the heterocyclic group, the alkylene group, the cycloalkylene group, the heterocycloalkylene group, the alkyl group, the cycloalkyl group, the heterocycloalkyl group, the aryl group, the heteroaryl group, and the alkoxy group include at least one substituent selected from the group consisting of —F, —Cl, —Br, —CN, —NO₂, or —OH; a C₁-C₂₀ alkyl group unsubstituted or substituted with —F, —Cl, —Br, —CN, —NO₂, or —OH; a C₁-C₂₀ alkoxy group unsubstituted or substituted with —F, —Cl, —Br, —CN, —NO₂, or —OH; a C₆-C₃₀ aryl group unsubstituted or substituted with —F, —Cl, —Br, —CN, —NO₂, or —OH; a C₂-C₃₀ heteroaryl group unsubstituted or substituted with —F, —Cl, —Br, —CN, —NO₂, or —OH; and a C₅-C₂₀ cycloalkyl group unsubstituted or substituted with —F, —Cl, —Br, —CN, —NO₂, and —OH.

4. The polymer of claim 1, wherein Ar₁ and Ar₂ are each independently selected from the group consisting of a phenylene group, a C₁-C₁₀ alkylphenylene group, a C₁-C₁₀ alkoxyphenylene group, a halophenylene group, a cyanophenylene group, a dicyanophenylene group, a trifluoromethoxyphenylene group, an o-, m-, or p-tolylene group, an o-, m-, or p-cumenylene group, a mesitylene group, a phenoxyphenylene group, an (α,α-dimethylbenzene)phenylene group, a (N,N′-dimethyl)aminophenylene group, a (N,N′-diphenyl)aminophenylene group, a (C₁-C₁₀ alkylcyclohexyl)phenylene group, an (anthracenyl)phenylene group, a biphenylene group, a C₁-C₁₀ alkylbiphenylene group, a C₁-C₁₀ alkoxybiphenylene group, a pentalenyl group, an indenylene group, a naphthylene group, a C₁-C₁₀ alkylnaphthylene group, a C₁-C₁₀ alkoxynaphthylene group, a halonaphthylene group, a cyanonaphthylene group, a biphenylenylene group, a C₁-C₁₀ alkyl biphenylenylene group, a C₁-C₁₀ alkoxy biphenylenylene group, an antracenylene group, an azulenylene group, a heptalenylene group, an acenaphthylenylene group, a phenalenylene group, a 9.9-dialkylfluorenylene group, a fluorenylene group, an anthraquinolylene group, a methylanthrylene group, a phenanthrenylene group, a triphenylenylene group, a pyrenylene group, a chrysenylene group, an ethyl-chrysenylene group, a picenylene group, a perylenylene group, a chloroperylenylene group, a pentaphenylene group, a pentacenylene group, a tetraphenylenylene group, a hexaphenylene group, a hexacenylene group, a rubicenylene group, a coronenylene group, a trinaphthylenylene group, a heptaphenylene group, a heptacenylene group, a pyranthrenylene group, an ovalenylene group, a carbazolylene group, a C₁₋₁₀ alkyl carbazolylene group, a thiophenylene group, an indolylene group, a purinylene group, a benzimidazolylene group, a quinolinylene group, a benzothiophenylene group, a parathiazinylene group, a pyrrolylene group, a pyrazolylene group, an imidazolylene group, an imidazolinylene group, an oxazolylene group, a thiazolylene group, a triazolylene group, a tetrazolylene group, an oxadiazolylene group, a pyridinylene group, a pyridazinylene group, a pyrimidinylene group, a pyrazinylene group, a thianthrenylene group, a pyrrolidinylene group, a pyrazolidinylene group, an imidazolidinylene group, a piperidinylene group, a piperazinylene group, and a morpholinylene group.

5. The polymer of claim 1, wherein L₁ is selected from the group consisting of a phenylene group, a C₁-C₁₀ alkylphenylene group, a C₁-C₁₀ alkoxyphenylene group, a halophenylene group, a cyanophenylene group, a dicyanophenylene group, a trifluoromethoxyphenylene group, an o-, m-, or p-tolylene group, an o-, m-, or p-cumenylene group, a mesitylene group, a phenoxyphenylene group, an (α,α-dimethylbenzene)phenylene group, a (N,N′-dimethyl)aminophenylene group, a (N,N′-diphenyl)aminophenylene group, a (C₁-C₁₀ alkylcyclohexyl)phenylene group, an (anthracenyl)phenylene group, a biphenylene group, a C₁-C₁₀alkylbiphenylene group, a C₁-C₁₀ alkoxybiphenylene group, a pentalenylene group, an indenylene group, a naphthylene group, a C₁-C₁₀ alkylnaphthylene group, a C₁-C₁₀ alkoxynaphthylene group, a halonaphthylene group, a cyanonaphthylene group, a biphenylenylene group, a C₁-C₁₀ alkyl biphenylenylene group, a C₁-C₁₀ alkoxy biphenylenylene group, an antracenylene group, an azulenylene group, a heptalenylene group, an acenaphthylenylene group, a phenalenylene group, a fluorenylene group, a 9,9-dialkylfluorenylene group, an anthraquinolylene group, a methylanthrylene group, a phenanthrenylene group, a triphenylenylene group, a pyrenylene group, a chrysenylene group, an ethyl-chrysenylene group, a picenylene group, a perylenylene group, a chloroperylenylene group, a pentaphenylene group, a pentacenylene group, a tetraphenylenylene group, a hexaphenylene group, a hexacenylene group, a rubicenylene group, a coronenylene group, a trinaphthylenylene group, a heptaphenylene group, a heptacenylene group, a pyranthrenylene group, an ovalenylene group, a carbazolylene group, a C₁₋₁₀alkyl carbazolylene group, a thiophenylene group, an indolylene group, a purinylene group, a benzimidazolylene group, a quinolinylene group, a benzothiophenylene group, a parathiazinylene group, a pyrrolylene group, a pyrazolylene group, an imidazolylene group, an imidazolinylene group, an oxazolylene group, a thiazolylene group, a triazolylene group, a tetrazolylene group, an oxadiazolylene group, a pyridinylene group, a pyridazinylene group, a pyrimidinylene group, a pyrazinylene group, a thianthrenylene group, a pyrrolidinylene group, a pyrazolidinylene group, an imidazolidinylene group, a piperidinylene group, a piperazinylene group, a carbazolylene group, a benzoxazolylene group, a phenothiazinylene group, a 5H-dibenzoazepinylene group, a 5H-tribenzoazepinylene group, a morpholinylene group, a methylene group, an ethylene group, a propylene group, a butylene group, a pentylene group, an ether group(—O—), —OCH₂—, —OCH₂CH₂—, —OCH₂CH₂CH₂—, —N(CH₃)—, and —N(CH₂CH₃)—.

6. The polymer of claim 1, wherein L₂ is selected from the group consisting of hydrogen, halogen, a methyl group, an ethyl group, a propyl group, a butyl group, a methoxy group, an ethoxy group, a propoxy group, a butoxy group, a C₁-C₁₀ alkylamine group, a C₁-C₁₀ thioalkyl group, a phenyl group, a C₁-C₁₀ alkylphenyl group, a C₁-C₁₀ alkoxyphenyl group, a halophenyl group, a cyanophenyl group, a dicyanophenyl group, a trifluoromethoxyphenyl group, an o-, m-, or p-tolyl group, an o-, m-, or p-cumenyl group, a mesityl group, a phenoxyphenyl group, an (α,α-dimethylbenzene)phenyl group, a (N,N′-dimethyl)aminophenyl group, a (N,N′-diphenyl)aminophenyl group, a (C₁-C₁₀ alkylcyclohexyl)phenyl group, an (anthracenyl)phenyl group, a biphenyl group, a C₁-C₁₀ alkylbiphenyl group, a C₁-C₁₀ alkoxybiphenyl group, a pentalenyl group, an indenyl group, a naphthyl group, C₁-C₁₀ alkylnaphthyl group, a C₁-C₁₀ alkoxynaphthyl group, a halonaphthyl group, a cyanonaphthyl group, a biphenylenyl group, a C₁-C₁₀ alkyl biphenylenyl group, a C₁-C₁₀ alkoxy biphenylenyl group, an anthracenyl group, an azulenyl group, a heptalenyl group, an acenaphthylenyl group, a phenalenyl group, a fluorenyl group, a 9,9-dialkylfluorenyl group, an anthraquinolyl group, a methylanthryl group, a phenanthrenyl group, a triphenylenyl group, a pyrenyl group, a chrysenyl group, an ethyl-chrysenyl group, a picenyl group, a perylenyl group, a chloroperylenyl group, a pentaphenyl group, a pentacenyl group, a tetraphenylenyl group, a hexaphenyl group, a hexacenyl group, a rubicenyl group, a coronenyl group, a trinaphthylenyl group, a heptaphenyl group, a heptacenyl group, a pyranthrenyl group, an ovalenyl group, a carbazolyl group, a cyclopentyl group, and a cyclohexyl group.

7. The polymer of claim 1, wherein L₂ is represented by one from the group consisting of formulae below:

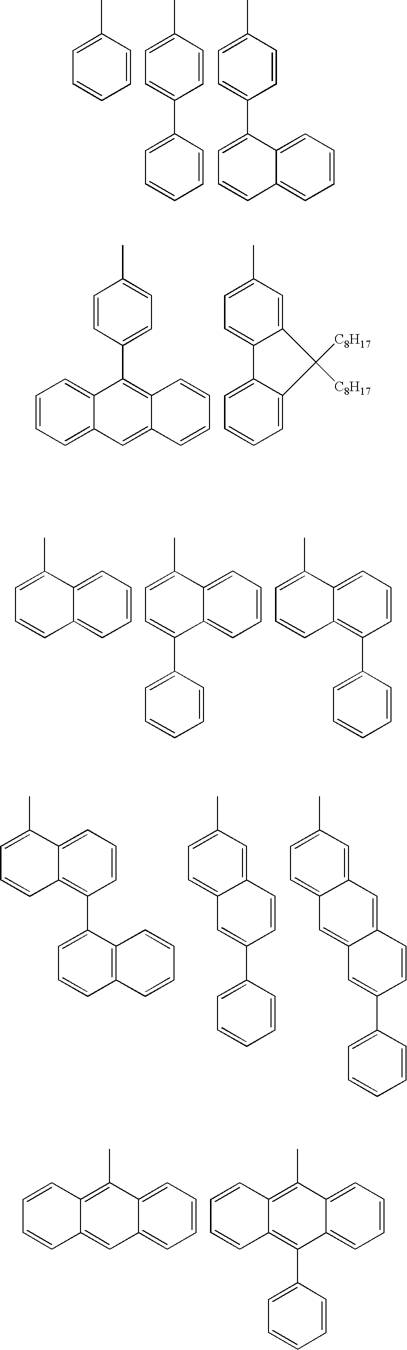

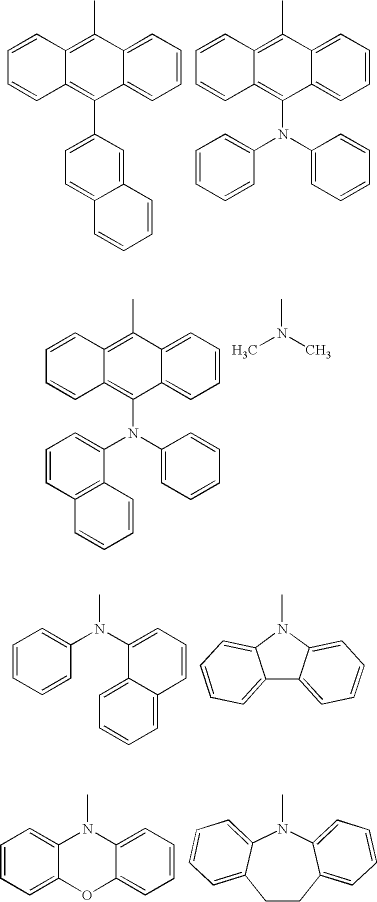

8. The polymer of claim 1, wherein an average molecular weight of the polymer is 10,000 to 120,000.

9. The polymer of claim 1, wherein a glass transition temperature of the polymer is 120 to 200° C.

10. The polymer of claim 1, being represented by one selected from the group consisting of Formulae 3 through 5:

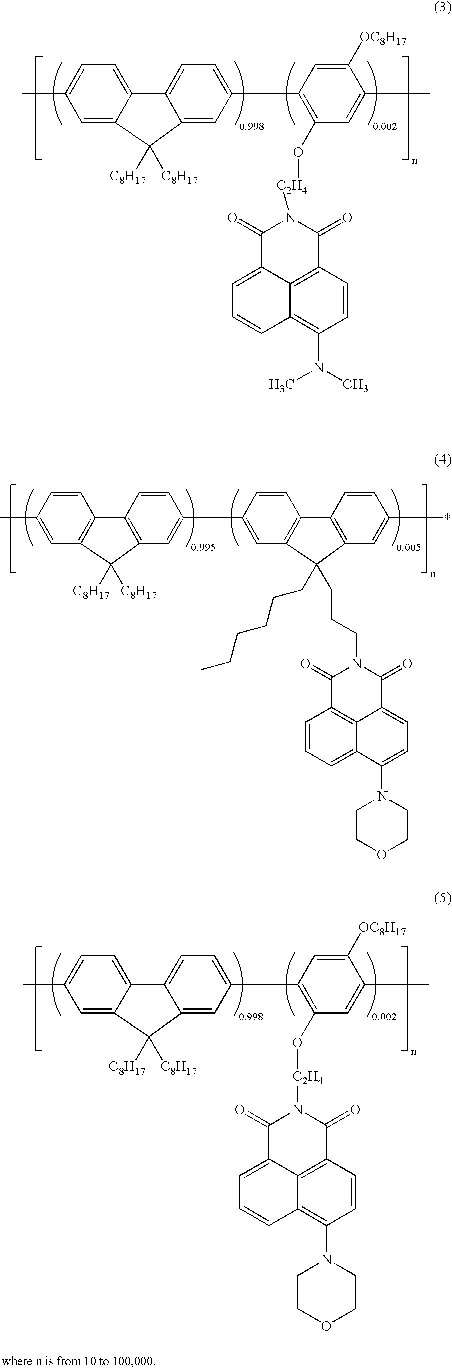

11. A composition for a light emitting layer of a light emitting device, the composition comprising:
a polymer of claim 1; and
a phosphorescent or fluorescent dopant which emits red, green, blue, or white light.

12. An optoelectronic device including a polymer of claim 1.

13. An organic light emitting device comprising an organic layer including a polymer of claim 1.

14. An organic light emitting device comprising:
a first electrode;
a second electrode; and
an organic layer interposed between the first electrode and the second electrode, the organic layer comprising a polymer represented by Formula 1: 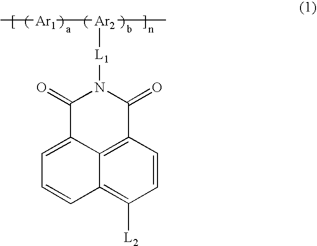
where Ar₁ and Ar₂ is each independently a substituted or unsubstituted C₆-C₃₀ arylene group, a substituted or unsubstituted C₂-C₃₀ heteroarylene group, a substituted or unsubstituted C₅-C₃₀ carbon ring group, or a substituted or unsubstituted C₂-C₃₀ heterocyclic group, and each of Ar₁ and Ar₂ may be the same or different;
L₁ is a substituted or unsubstituted C₆-C₃₀ arylene group, a substituted or unsubstituted C₂-C₃₀ heteroarylene group, a substituted or unsubstituted C₁-C₂₀ alkylene group, a substituted or unsubstituted C₁-C₂₀ cycloalkylene group, a substituted or unsubstituted C₁-C₂₀ heterocycloalkylene group, ether group, —N(L₂)— group, or —O—(CH₂)ₘ— group;
L₂ is hydrogen, halogen, a substituted or unsubstituted C₁-C₂₀ alkyl group, a substituted or unsubstituted C₁-C₂₀ cycloalkyl group, a substituted or unsubstituted C₁-C₂₀ heterocycloalkyl group, a substituted or unsubstituted C₆-C₃₀ aryl group, a substituted or unsubstituted C₂-C₃₀ heteroaryl group, an alkoxy group, an amine group, an alkylamine group, or a thioalkyl group;
n is a degree of polymerization which is a real number from 10 to 100,000;
a and b are molar ratios, where a+b=1 and 0.001≦b≦0.3; and
m is an integer from 1 to 20.

15. The organic light emitting device of claim 14, wherein the organic layer comprising the polymer is one of a light emitting layer and a hole transport layer.

16. The organic light emitting device of claim 14, wherein the device further includes at least one layer interposed between the first electrode and the second electrode selected from the group consisting of a hole injection layer, a hole transport layer, an electron blocking layer, a hole blocking layer, an electron transport layer, and an electron injection layer.

17. The organic light emitting device of claims 14, wherein the device has a structure selected from the group consisting of a first electrode/hole injection layer/light emitting layer/electron transport layer/electron injection layer/second electrode structure, a first electrode/hole injection layer/hole transport layer/light emitting layer/electron transport layer/electron injection layer/second electrode structure, and a first electrode/hole injection layer/hole transport layer/light emitting layer/hole blocking layer/electron transport layer/electron injection layer/second electrode structure.

18. The organic light emitting device of claim 15, wherein the light emitting layer comprises a phosphorescent or fluorescent dopant which emits red, green, blue, or white light.

19. An organic light emitting device comprising:
a first electrode;
a second electrode; and
an organic layer interposed between the first electrode and the second electrode, the organic layer comprising a light emitting layer and a hole transport layer interposed between the light emitting layer and the first electrode, the light emitting layer comprising a polymer doped with a dopant, the polymer represented by Formula 1: 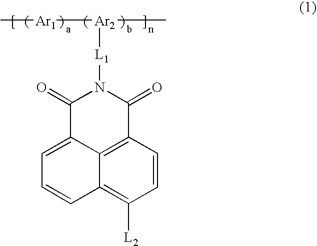
where Ar₁ and Ar₂ is each independently a substituted or unsubstituted C₆-C₃₀ arylene group, a substituted or unsubstituted C₂-C₃₀ heteroarylene group, a substituted or unsubstituted C₅-C₃₀ carbon ring group, or a substituted or unsubstituted C₂-C₃₀ heterocyclic group, and each of Ar₁ and Ar₂ may be the same or different;
L₁ is a substituted or unsubstituted C₆-C₃₀ arylene group, a substituted or unsubstituted C₂-C₃₀ heteroarylene group, a substituted or unsubstituted C₁-C₂₀ alkylene group, a substituted or unsubstituted C₁-C₂₀ cycloalkylene group, a substituted or unsubstituted C₁-C₂₀ heterocycloalkylene group, ether group, —N(L₂)— group, or —O—(CH₂)ₘ— group;
L₂ is hydrogen, halogen, a substituted or unsubstituted C₁-C₂₀ alkyl group, a substituted or unsubstituted C₁-C₂₀ cycloalkyl group, a substituted or unsubstituted C₁-C₂₀ heterocycloalkyl group, a substituted or unsubstituted C₆-C₃₀ aryl group, a substituted or unsubstituted C₂-C₃₀ heteroaryl group, an alkoxy group, an amine group, an alkylamine group, or a thioalkyl group;
n is a degree of polymerization which is a real number from 10 to 100,000;
a and b are molar ratios, where a+b=1 and 0.001≦b≦0.3; and
m is an integer from 1 to 20.

20. The organic light emitting device of claim 19, wherein an average molecular weight of the polymer is 10,000 to 120,000.
